(19) United States
(12) Patent Application Publication
(10) Pub. No.: US 2024/0276351 A1
(43) Pub. Date: Aug. 15, 2024

(54) CELLULAR TELECOMMUNICATIONS NETWORK

(71) Applicant: BRITISH TELECOMMUNICATIONS PUBLIC LIMITED COMPANY, LONDON (GB)

(72) Inventors: Richard Thomas MacKenzie, London (GB); Douglas Francis Fripp, London (GB)

(21) Appl. No.: 18/570,170

(22) PCT Filed: Jun. 10, 2022
(86) PCT No.: PCT/EP2022/065836

§ 371 Date: Dec. 14, 2023

(30) Foreign Application Priority Data
Jun. 17, 2021 (GB) 2108635.0

(51) Int. Cl. H04W 48/08

(52) U.S. Cl. CPC H04W 48/08

(57) ABSTRACT

This disclosure provides a method of operating a management node in a cellular telecommunications network, the cellular telecommunications network including a first base station and a User Equipment (UE), the management node storing a first set of tracking area codes, wherein the first base station is configured to transmit a first tracking area code and the UE is configured to send a tracking area update request message to the first base station identifying the first tracking area code, the method including receiving a request message from the first base station, the request including the first tracking area code identified in the tracking area update request message; comparing the received first tracking area code to the first set of tracking area codes; and sending a response message to the first base station, the response message accepting or rejecting the tracking area request based on the comparison.

### PRIORITY CLAIM

The present application is a National Phase entry of PCT Application No. PCT/EP2022/065836, filed Jun. 10, 2022, which claims priority from GB Application No. 2108635.0, filed Jun. 17, 2021, each of which hereby fully incorporated herein by reference.

### TECHNICAL FIELD

The present disclosure relates to a cellular telecommunications network.

### BACKGROUND

In cellular telecommunications networks, a User Equipment (UE) and base station may communicate using a cellular telecommunications protocol. Voice service is a key component of these protocols to enable voice traffic to be communicated from a UE to another node in the cellular telecommunications network (typically another UE). In many early telecommunications protocols, such as the 2^{nd} Generation (2G) protocol defined by the Global System for Mobile Communication (GSM) and the 3^{rd} Generation (3G) protocol defined by 3^{rd} Generation Partnership Project (3GPP), voice services utilized circuit switched data transmission. In other, typically more recent, cellular telecommunications protocols, such as the 4th Generation (4G) and 5th Generation (5G) protocols defined by 3GPP, voice services utilized packet switched data transmission (e.g. Voice-Over-Internet-Protocol, VOIP).

As new generations of telecommunications protocol are introduced, Mobile Network Operators (MNOs) must upgrade or replace their infrastructure to support users of these new generations. As the number of users of the older telecommunications protocols decreases, it becomes less economically viable to operate the older infrastructure. Nonetheless, there are still reasons to maintain this older infrastructure, such as to provide access to an emergency services network to users that can only access such a network through a circuit switched voice service.

### SUMMARY

According to a first aspect of the disclosure, there is provided a method of operating a first base station in a cellular telecommunications network, wherein the cellular telecommunications network includes a User Equipment, UE, and a management node, the management node being configured to determine, based on a tracking area code, whether a base station associated with the tracking area code supports a circuit switched voice service, the method comprising determining whether the first base station supports a circuit switched voice service; transmitting a first tracking area code if the first base station supports the circuit switched voice service, or otherwise transmitting a second tracking area code; on receipt of a tracking area update request message from the UE identifying the first or second tracking area code transmitted by the first base station, sending a first message to the management node including the first or second tracking area code identified in the tracking area update request message; and on receipt of a response message from the management node indicating whether the UE is accepted or rejected by the management node, sending a second message to the UE including the acceptance or rejection indicated in the response message.

Determining whether the first base station supports the circuit switched voice service may include a determination of whether the circuit switched voice service has entered energy saving mode, a determination of whether the circuit switched voice service is supported in a geographical area, or a determination of whether the circuit switched voice service has a spectrum assignment.

According to a second aspect of the disclosure, there is provided a method of operating a management node in a cellular telecommunications network, the cellular telecommunications network including a first base station and a User Equipment, UE, the management node storing a first set of tracking area codes, wherein the first base station is configured to transmit a first tracking area code and the UE is configured to send a tracking area update request message to the first base station identifying the first tracking area code, the method comprising receiving a request message from the first base station, the request including the first tracking area code identified in the tracking area update request message; comparing the received first tracking area code to the first set of tracking area codes; and sending a response message to the first base station, the response message accepting or rejecting the tracking area request based on the comparison.

Each of the first set of tracking area codes may be associated with a base station that supports a circuit switched voice service, and accepting or rejecting the tracking area request may include accepting the tracking area request if the received tracking area code is one of the first set of tracking area codes.

Each of the first set of tracking area codes may be associated with a base station that does not support a circuit switched voice service, and accepting or rejecting the tracking area request may include rejecting the tracking request if the receiving tracking area code is one of the first set of tracking area codes.

The management node may store a second set of tracking area codes and each of the second set of tracking area codes may be associated with a base station that does not support a circuit switched voice service, and accepting or rejecting the tracking area request may include rejecting the tracking area request if the received tracking area code is one of the second set of tracking area codes.

The response message may identify the first tracking area code as forbidden.

According to a third aspect of the disclosure, there is provided a computer program comprising instructions which, when the program is executed by a computer, cause the computer to carry out the method of the first or second aspect of the disclosure. The computer program may be stored on a computer readable carrier medium.

According to a fourth aspect of the disclosure, there is provided a first base station for a cellular telecommunications network having a processor configured to carry out the first aspect of the disclosure.

According to a fifth aspect of the disclosure, there is provided a management node for a cellular telecommunications network having a processor configured to carry out the method of the second aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of a cellular telecommunications network of a first embodiment of the present disclosure.

FIG. 2 is a schematic diagram of the network of FIG. 1 in a first state.

FIG. 3 is a schematic diagram of the network of FIG. 1 in a second state.

FIG. 4 is a flow diagram of a first embodiment of a method of the present disclosure.

FIG. 5 is a flow diagram of a process implemented in the first, second, and third embodiments of the present disclosure.

FIG. 6 is a schematic diagram of a cellular telecommunications network of a second embodiment of the present disclosure.

FIG. 7 is a flow diagram of a method of the second embodiment of the present disclosure.

FIG. 8 is a schematic diagram of a cellular telecommunications network of the third embodiment of the present disclosure.

FIG. 9 is a flow diagram of a method of the third embodiment of the present disclosure.

### DETAILED DESCRIPTION OF EMBODIMENTS

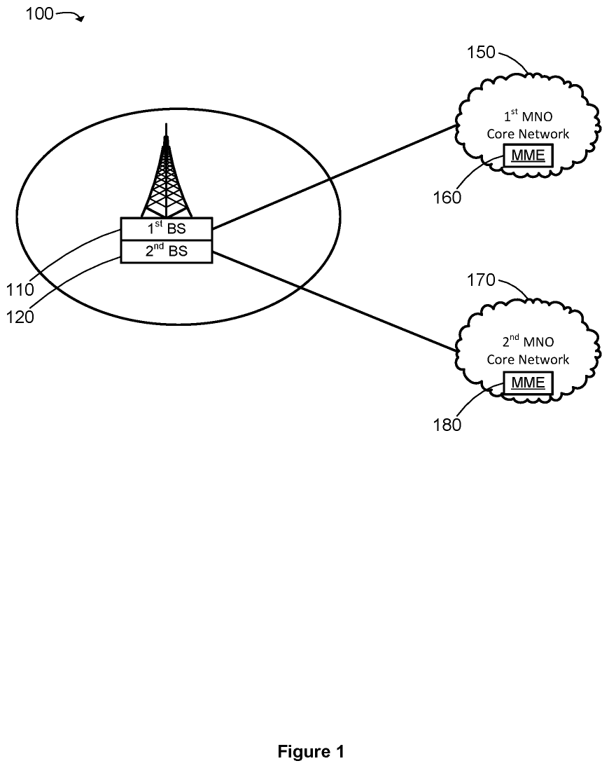

A first embodiment of a cellular telecommunications network 100 will now be described with reference to FIG. 1. FIG. 1 illustrates a first base station 110 of a first Mobile Network Operator (MNO). The first base station 110 connects to a first core network 150 of the first MNO, which includes a first Mobility Management Entity (MME) 160. FIG. 1 also illustrates a second base station 120 of a second MNO, which connects to a second core network 170 of the second MNO, which includes a second MME 180.

The first base station 110 and second base station 120 are each configured to transmit a tracking area code. In the following embodiments, the first base station 110 is configured to transmit a first tracking area code if the first base station 110 provides a circuit switched voice service for users of the first MNO's network and to transmit a second tracking area code if the first base station 100 does not provide a circuit switched voice service to users of the first MNO's network. Similarly, the second base station 120 is configured to transmit a third tracking area code if the second base station 120 provides a circuit switched voice service to users of the second MNO's network and to transmit a fourth tracking area code if the second base station 120 does not provide a circuit switched voice service to users of the second MNO's network.

The first MME 160 stores a database of tracking area codes in which a first set of tracking area codes are associated with base stations that provide a circuit switched voice service to users of the first MNO's network and a second set of tracking area codes are associated with base stations that do not provide a circuit switched voice service to users of the first MNO's network. In this embodiment, the first set of tracking area codes stored in the first MME's database includes the first tracking area code, and the second set of tracking area codes stored in the first MME's database includes the second tracking area code.

Similarly, the second MME 180 stores a database of tracking area codes in which a first set of tracking area codes are associated with base stations that provide a circuit switched voice service to users of the second MNO's network and a second set of tracking area codes are associated with base stations that do not provide a circuit switched voice service to users of the second MNO's network. In this embodiment, the first set of tracking area codes stored in the second MME's database includes the third tracking area code, and the second set of tracking area codes stored in the second MME's database includes the fourth tracking area code.

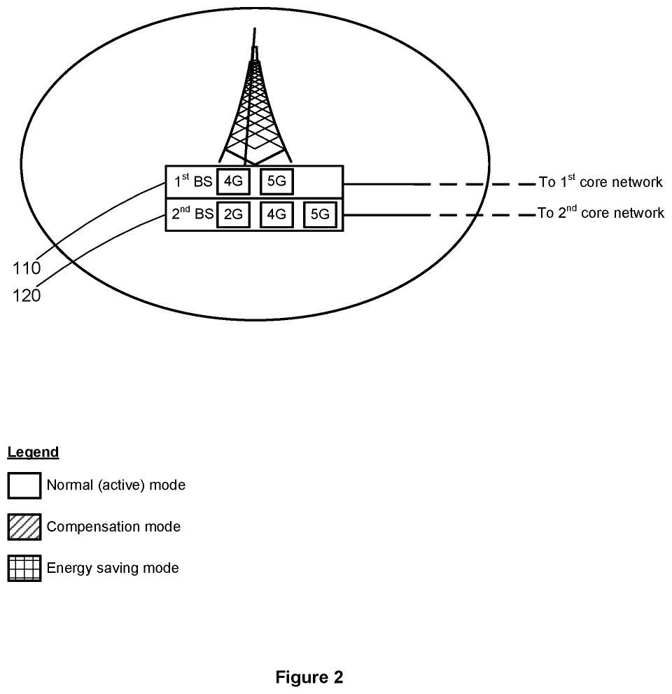

A first embodiment of a method of the present disclosure will now be described with reference to FIGS. 2 to 4. As shown in FIG. 2, the first and second base stations 110, 120 are in an initial configuration in which the first base station 110 is configured to provide a “4G” service (i.e. based on one or more of Release 8 to Release 14 of the 3^{rd} Generation Partnership Project (3GPP)), and a “5G” service (i.e. based on one or more of Release 15 and any subsequent Release of 3GPP considered as a 5G service), and the second base station 120 is configured to provide 4G and 5G services and is further configured to provide a “2G” service (i.e. based on one or more of the Global System for Mobile Communications (GSM) specifications). The first base station 110 therefore provides packet switched voice services via Voice of Internet Protocol (VoIP) technology, and the second base station 120 provides packet switched voice services via VoIP for any 4G and 5G users or via a circuit switched voice service for 2G users (the VoIP 4G/5G service is optional, as the 2G voice service may be used for all voice services and 4G/5G used for data services).

In this initial configuration, the first base station 110 broadcasts the second tracking area code (indicating that it does not provide a circuit switched voice service to users of the first MNO's network) and the second base station 120 broadcasts the third tracking area code (indicating that it does provide a circuit switched voice service to users of the second MNO's network).

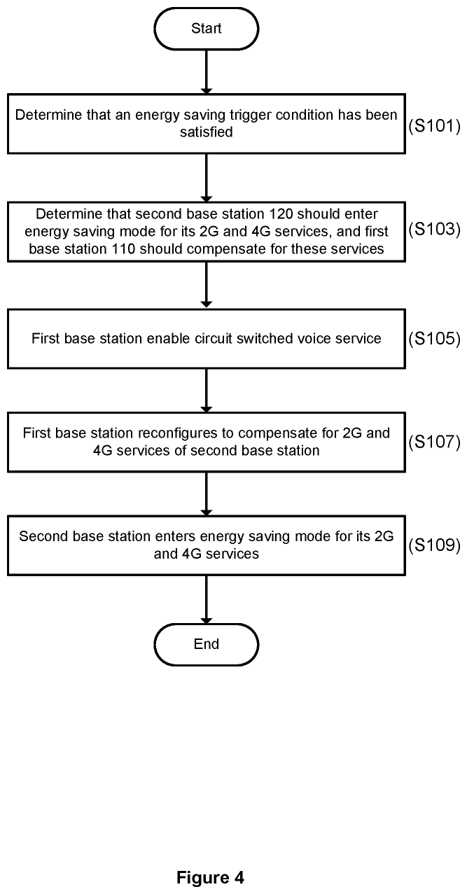

In S101 of this embodiment, as shown in the flow diagram of FIG. 4, the second base station 120 determines that an energy saving trigger condition has been satisfied. In S103, it is determined (e.g. by negotiation between the first and second base stations 110, 120) that the second base station 120 should enter energy saving mode for its 2G and 4G services (thus maintaining its 5G service), and the first base station 110 should enable a 2G service and enter compensation mode for the second base station's 2G and 4G services.

In S105, the first base station 110 enables a 2G service. The first base station 110 may enable the 2G service by activating a 2G radio function and utilizing the first MNO's 2G licensed spectrum (that previously wasn't being used by the first base station 110). In other implementations, the first base station 110 may reassign spectrum (“refarm”) from other protocols (e.g. the first MNO's 4G and/or 5G spectrum) to be used for 2G services, use some of second MNO's licensed spectrum (either the 2G spectrum or refarmed 4G spectrum) for 2G services (e.g. under a spectrum sharing agreement), use shared licensed spectrum (e.g. Licensed Shared Access), or unlicensed spectrum.

In S107, the first base station 110 reconfigures to compensate for the second base station 120. This includes a switch from a Multi-Operator Radio Access Network (MORAN) configuration to a Multi-Operator Core Network (MOCN) configuration, in which the first base station 110 begins transmitting both the first MNO's Public Land Mobile Network (PLMN) identifier and the second MNO's PLMN identifier, and accepts handovers and redirections of all users being served by the second base station 120. As part of this reconfiguration, the first base station 110 connects to both the first MME 160 of the first MNO's core network and the second MME 180 of the second MNO's core network. As the first base station 110 is enabling a 2G service for at least users of the second MNO's network, the first base station 110 retrieves, from the second MME 180, the third tracking area code indicating that it provides a circuit switched voice service to users of the second MNO's network. The first base station 110 then broadcasts this third tracking area code.

Additionally, in a scenario where the newly-enabled 2G service of the first base station 110 may also be used by users of the first MNO's network, then the first base station 110 switches from broadcasting the second tracking area code to broadcasting the first tracking area code (indicating that it also provides a circuit switched voice service to users of the first MNO's network) in addition to broadcasting the third tracking area code.

Following these reconfigurations, any 2G and/or 4G traffic for the second MNO's users now being served by the first base station 110 is routed between the first base station 110 and the second MNO's core network.

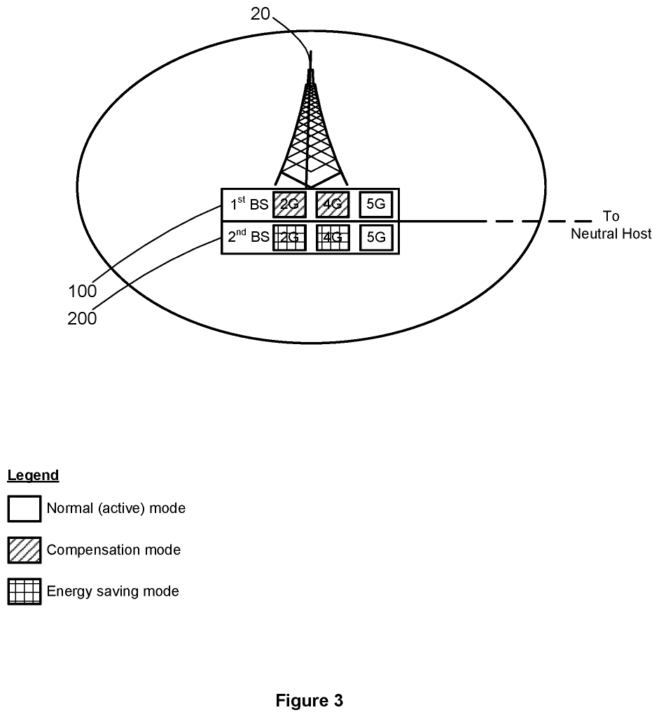

In S109, the second base station 120 enters energy saving mode for its 2G and 4G services. As part of this reconfiguration, the second base station 120 switches from broadcasting the third tracking area code to broadcasting the fourth tracking area code (indicating that it does not provide a circuit switched voice service to users of the second MNO's network). The final state of the network is illustrated in FIG. 3.

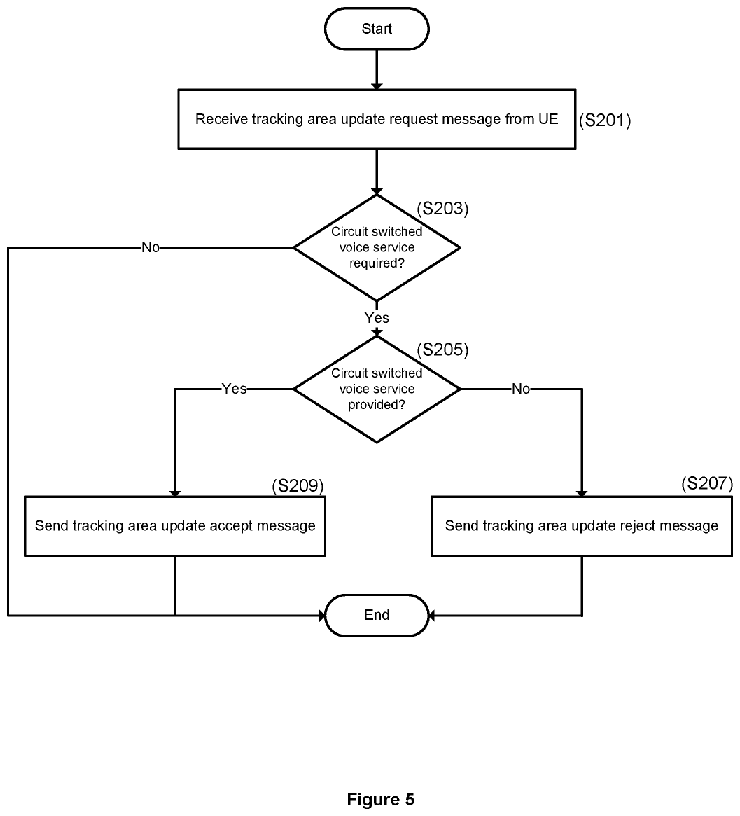

This first embodiment ensures a User Equipment (UE) that requires a circuit switched voice service (for example, a UE that is not configured for voice services of the 4G and 5G cellular telecommunications protocols) does not connect to a base station that no longer provides a circuit switched voice service. This process is illustrated by the flow diagram of FIG. 5. When a UE that requires a circuit switched voice service, that is not connected to the second base station 120, receives the fourth tracking area code broadcast by the second base station 120, it may initiate a tracking area code update process. As part of this process, the UE sends a tracking area update request to the second MME 180, via the second base station 120, which includes the fourth tracking area code (received at the second MME 180 in S201). On receipt of the tracking area update request, in S203, the second MME 180 determines whether the UE requires a circuit switched voice service based on the capabilities of the UE. These capabilities may already be known to the second MME 180 (from an earlier capability signaling procedure) or retrieved on receipt of the tracking area update request (e.g. by retrieving its subscription status from the Home Subscriber Server (HSS)). In this example, the second MME 180 determines that the UE requires a circuit switched voice service and the process continues to S205 in which the second MME 180 determines whether or not the second base station 120 provides a circuit switched voice service to users of the second MNO's network. This is achieved, in this embodiment, by performing a lookup operation with its database of tracking area codes (which are each marked as being for base stations that either provide circuit switched voice service to users of the second MNO's network or do not provide circuit switched voice service to users of the second MNO's network) to determine whether or not the fourth tracking area code is associated with base stations that provide a circuit switched voice service to users of the second MNO's network. In this example, the second MME 180 determines from this lookup operation that the second base station 180 does not provide a circuit switched voice service to users of the second MNO's network. Accordingly, in S207, the second MME sends a tracking area update reject message to the UE. This prevents the UE from connecting to the second base station 120 when the second base station 120 does not provide a circuit switched voice service.

Furthermore, in this embodiment, the tracking area update reject message includes a cause code that causes the UE to update a list of forbidden tracking area codes with the fourth tracking area code. This will prevent the UE from connecting to any base station that transmits the fourth tracking area code without having to perform the tracking area update/reject process outlined above. This list of forbidden tracking area codes is stored in the UE until it is reset.

Following the rejected tracking area update request, the UE may connect to a base station that provides a circuit switched voice service, such as the first base station 110 that has enabled a circuit switched voice service. That is, following the above process of FIG. 5, when the UE receives the third tracking area code broadcast by the first base station 110 and sends a tracking area update request to the first base station 110, the first base station 110 forwards the tracking area update request message to the second MME 180 (using the connection established to the second MNO's core network as part of the switch to MOCN mode). The second MME 180 determines that the third tracking area code broadcast by the first base station 110 indicates that the first base station 110 does provide a circuit switched voice service to users of the second MNO's network and, in response, sends a tracking area update accept message to the UE (S209) permitting the UE to connect to the first base station 110.

The skilled person will understand that it is non-essential that the first and second base stations are operated by distinct operators. That is, in a single operator implementation of the first embodiment, the first and second base stations would transmit a first tracking area code if they provided a circuit switched voice service and a second tracking area code if they did not provide a circuit switched voice service, and a single MME would store these first and second tracking area codes in a database.

Furthermore, it is non-essential that the compensating base station enables a circuit switched voice service in order to compensate for the circuit switched voice service that is entering energy saving mode. That is, the compensating base station may already provide a circuit switched voice service (although there may be a requirement for reconfiguring this service to make it available to users of another network). This situation may arise where the energy saving base station is a femtocell and the compensating base station is a macrocell.

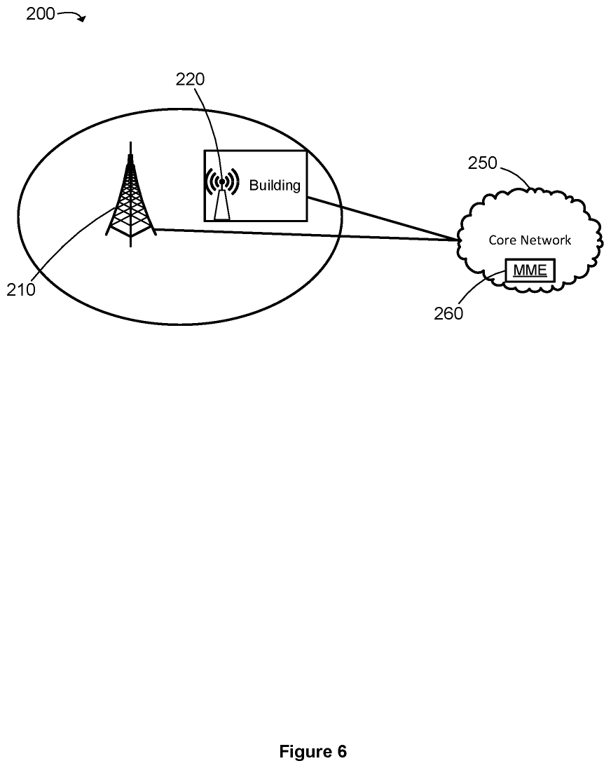

A second embodiment of a cellular telecommunications network 200 of the present disclosure will now be described with reference to FIG. 6. This second embodiment includes a first base station 210, a second base station 220, a core network 250, and an MME 260. The first and second base stations 210, 220 are both connected to the core network 250 and MME 260.

FIG. 6 further illustrates a building defining an interior space. The second base station 220 is positioned in the building and provides a 4G service throughout the interior space of the building. The first base station 210 is positioned outside the building and provides a circuit switched voice service according to the 2G cellular telecommunications protocol. The first base station 210 is configured to provide circuit switched voice service to the second base station's users by circuit switched fallback. In other words, the second base station 220 supports a circuit switched voice service via fallback to the first base station 210.

In this embodiment, the first base station 210 is configured to manage its load (as defined by utilization of the first base station's resources, such as radio resources or processing resources) by varying its coverage area. For example, if the first base station's load satisfies a threshold indicating that it is operating at a relatively high load, then in response the first base station 210 decreases its coverage area (by reducing its transmission power) so that users at the edge of the first base station's coverage area are encouraged to transfer to another base station. This reduces the number of served users for the first base station 210, thus reducing its load. Conversely, if the first base station's load satisfies a threshold indicating that it is operating at a relatively low load, then in response the first base station 210 increases its coverage area (by increasing its transmission power) so that more users are transferred to the first base station 210. This increases the number of served users for the first base station 210, thus increasing its load. This operation is known as “cell-breathing”.

As the first base station's transmission power is variable, the coverage area of the first base station 210 may or may not cover the interior space of the building depending on whether the first base station's transmission power meets a transmission power threshold. This transmission power threshold therefore represents the minimum transmission power required for the first base station's coverage area to cover the interior space of the building. This transmission power threshold may be determined by the second base station 220, by the second base station's users and/or by operator measurements of the first base station's signal strength (e.g. Signal-to-Interference-plus-Noise Ratio (SINR)) in the interior space of the building at various transmission powers so as to determine the minimum transmission power required for a UE to receive service from the first base station 210 in the interior space. Alternatively, the threshold may be calculated using a propagation model. The transmission power threshold is stored in the second base station's memory.

In this embodiment, the second base station 220 is configured to transmit a first tracking area code if the second base station 220 supports a circuit switched voice service (that is, when the first base station's transmission power is above the transmission power threshold), and the second base station 220 is configured to transmit a second tracking area code if the second base station 220 does not support a circuit switched voice service (that is, when the transmission power of the first base station 210 is below the transmission power threshold). The MME 180 stores a database of tracking area codes in which a first set of tracking area codes are associated with base stations that support a circuit switched voice service to users in the interior space of the building and a second set of tracking area codes are associated with base stations that do not support a circuit switched voice service to the interior space of the building. In this embodiment, the first set of tracking area codes stored in the MME's database includes the first tracking area code, and the second set of tracking area codes stored in the MME's database includes the second tracking area code.

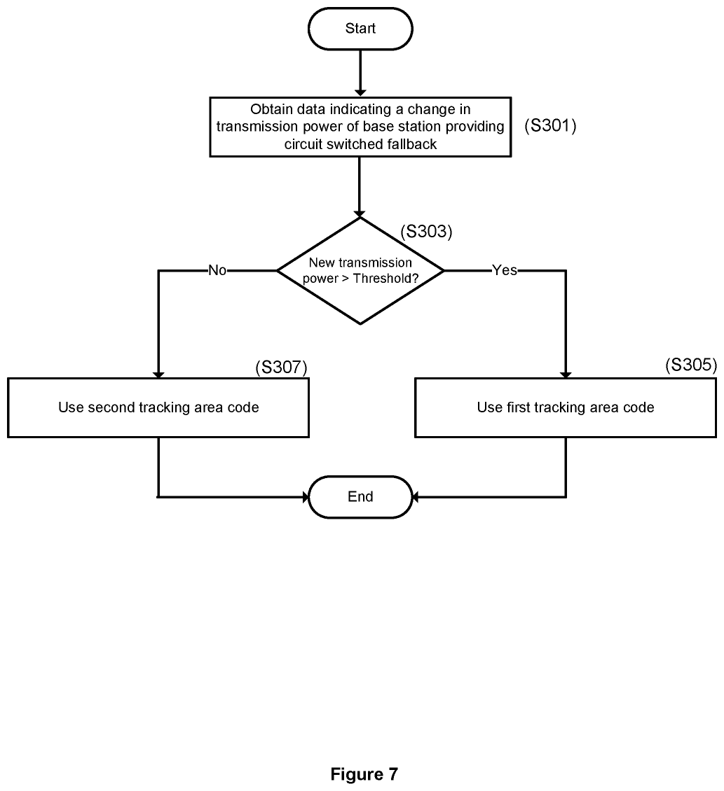

A second embodiment of a method of the present disclosure will now be described with reference to FIG. 7. In S301 of this second embodiment, the second base station 220 obtains data indicating a change in the transmission power of the first base station 210. This data may be obtained as an update message from another network entity (e.g. the first base station 210 via X2 messaging), from measurements by the second base station 220, or from measurements by the second base station's users. This data indicates that a change has occurred and further indicates a new transmission power for the first base station 210 (either explicitly, or indicates data from which the new transmission power can be derived). In S303, the second base station 220 determines whether the new transmission power satisfies the transmission power threshold. If the new transmission power is greater than the transmission power threshold, then (in S305) the second base station 220 is configured to use the first tracking area code (indicating that it supports a circuit switched voice service to users in the interior space of the building). If the new transmission power is less than the transmission power threshold then (in S307) the second base station 210 is configured to use the second tracking area code (indicating that it does not support a circuit switched voice service to users in the interior space of the building).

The cellular telecommunications network of this second embodiment may then follow the process described in reference to FIG. 5 so as to ensure that UE that require a circuit switched voice service only connect to the second base station 220 if it supports a circuit switched voice service in a particular region (e.g. the interior space of the building). For example, if the first base station 210 configures its transmission power such that it does not cover the interior space of the building such that the second base station 220 transmits the second tracking area code, then a UE positioned in the interior space of the building would send a tracking area update request message to the MME on receipt of the second tracking area code transmitted by the second base station 220 within the interior space of the building. This results in a tracking area update reject message from the MME, thus ensuring that the UE would not be able to connect to the second base station 220. Conversely, if the first base station 210 configures its transmission power such that it does cover the interior space of the building such that the second base station 220 transmits the first tracking area code, then a UE positioned in the interior space of the building and requiring a circuit switched voice service would send a tracking area update request message to the MME on receipt of the first tracking area code from the second base station 220. This results in a tracking area update accept message from the MME, such that the UE would be able to connect to the second base station 220. This second embodiment therefore provides the benefit of using tracking area codes to control access based on the relative position of the UE to the base station's circuit switched voice service coverage area.

The skilled person will understand that the above second embodiment applies to other scenarios where a circuit switched voice service has a changeable coverage area. This may apply, for example, where a base station transmits both a 2G and 4G service, but varies the coverage area of the 2G service.

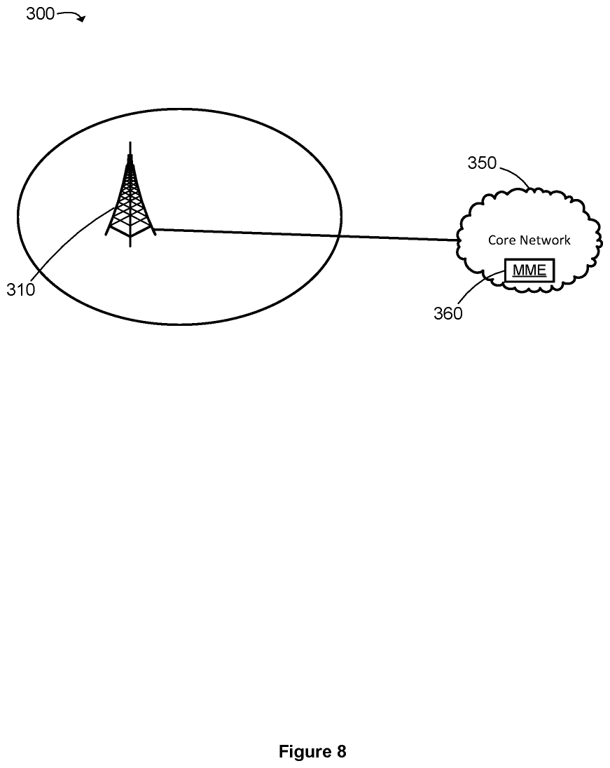

A third embodiment of a cellular telecommunications network 300 will now be described with reference to FIG. 8. This third embodiment includes a first base station 310, a core network 350, and an MME 360. The first base station 310 is connected to the first core network 350 and first MME 360.

In this third embodiment, the first base station 310 is configured for communications according to a plurality of protocols, in which at least one of these protocols includes circuit switched voice service. In this example, the first base station 310 is configured to provide both a 2G service and a 4G service. The first base station 310 is also configured to reassign spectrum between the 2G and 4G services, such that some or all of the 2G spectrum may be reassigned for use by the 4G service (and vice-versa).

The first base station 310 is further configured to transmit a tracking area code. In this embodiment, the first base station 310 is configured to transmit a first tracking area code if the first base station provides a circuit switched voice service (that is, at least some of the 2G spectrum is still being used for a 2G service) and to transmit a second tracking area code if it does not provide a circuit switched voice service (that is, all of the 2G spectrum has been reassigned to the 4G service). The MME 360 stores a database of tracking area codes in which a first set of tracking area codes are associated with base stations that provide a circuit switched voice service and a second set of tracking area codes are associated with base stations that do not provide a circuit switched voice service. In this embodiment, the first set of tracking area codes stored in the MME's database includes the first tracking area code, and the second set of tracking area codes stored in the MME's database includes the second tracking area code.

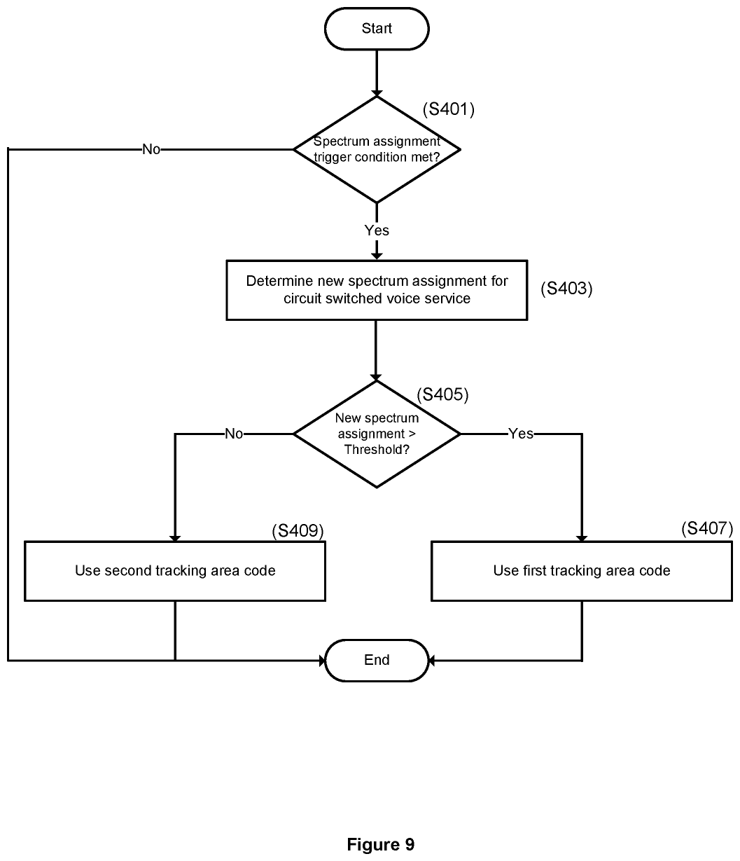

A third embodiment of a method of the present disclosure will now be described with reference to FIG. 9. In S401 of this third embodiment, it is determined that a trigger condition has been satisfied for the first base station 310 to change its spectrum assignment of its circuit switched voice service. In S403, the first base station 310 determines its new spectrum assignment for its circuit switched voice service. In S405, the third base station 300 determines whether the new spectrum assignment is greater than a spectrum assignment threshold required to provide the 2G service. This threshold may be OHz. If this determination is positive, then, in S407, the first base station 310 transmits the first tracking area code. If this determination is negative, then, in S409, the first base station 310 transmits the second tracking area code.

The cellular telecommunications network of this third embodiment may then follow the process described in reference to FIG. 5 so as to ensure that UE that require a circuit switched voice service only connect to the first base station 310 if it provides its circuit switched voice service. For example, if the first base station 310 has no spectrum assigned to its 2G service (that is, it has reassigned all 2G spectrum to its 4G service) and therefore transmits the second tracking area code, then a UE would send a tracking area update request message to the MME on receipt of the second tracking area code. If the UE requires a circuit switched voice service, then the MME would reject this tracking area update message, thus ensuring that the UE would not be able to connect to the first base station 310. Conversely, if the first base station 310 has a non-zero spectrum assignment for its 2G service and therefore transmits the first tracking area code, then a UE would send a tracking area update request message to the MME on receipt of the first tracking area code. If the UE required a circuit switched voice service, then the MME would accept this tracking area update message and the UE would be able to connect to the first base station 310. This third embodiment therefore provides the benefit of using tracking area codes to control access based on a current spectrum assignment to a circuit switched voice service when the base station implements spectrum refarming.

In the above embodiments, the circuit switched voice service is a GSM 2G service. However, this is non-essential and the skilled person would understand that the above embodiments may apply to a circuit switched voice service of any protocol, such as the 3G voice service (as standardized by 3GPP).

In the embodiments above, the tracking area codes transmitted by each base station indicate whether that base station either provides or does not provide a circuit switched voice service. However, the tracking area codes may more generally indicate whether that base station either supports or does not support a circuit switched voice service. That is, a base station may support a circuit switched voice service if it either provides a circuit switched voice service itself, or it does not provide a circuit switched voice service but facilitates fallback to a circuit switched voice service. Conversely, a base station may not support a circuit switched voice service if it does not provide a circuit switched voice service and it does not facilitate fallback to a circuit switched voice service. For example, in a modification to the first embodiment, following the reconfigurations of the first and second base stations (such that the first base station 100 enables a 2G service and the second base station 200 enters energy saving mode for its 2G service), the second base station 200 may still support circuit switched voice service to users of the second MNO's network if it facilitates circuit switched fallback to the first base station's newly enabled 2G service. In such a scenario, the second base station 200 may also broadcast the third tracking area code so that users (requiring circuit switched voice service) are permitted to connect to the second base station 200.

In the above embodiments, the MME stored a first set of tracking area codes identifying base stations that support or provide a circuit switched voice service and a second set of tracking area codes identifying base stations that do not support or provide a circuit switched voice service. This is non-essential and the skilled person will understand that other implementations are possible. For example, the MME may store a single list of tracking area codes which identify base stations that support or provide a circuit switched voice service, and the MME would then only permit access to a base station if the tracking area update request included a tracking area code on that list. In another example, the MME may store a single list of tracking area codes which identify base stations that do not support or provide a circuit switched voice service, and the MME would then only permit access to a base station if the tracking area update request included a tracking area code that is not on that list.

The skilled person will understand that any combination of features is possible within the scope of the disclosure, as claimed.

1-13. (canceled)

14. A method of operating a management node in a cellular telecommunications network, the cellular telecommunications network including a first base station and a User Equipment (UE) the management node storing a first set of tracking area codes, wherein the first base station is configured to transmit a first tracking area code and the UE is configured to send a tracking area update request message to the first base station identifying the first tracking area code, the method comprising:
receiving a request message from the first base station, the request message including the first tracking area code identified in the tracking area update request message;
comparing the received first tracking area code to the first set of tracking area codes; and
sending a response message to the first base station, the response message accepting or rejecting a tracking area request based on the comparison,
wherein:
each of the first set of tracking area codes is associated with a base station that supports a circuit switched voice service, and accepting or rejecting the tracking area request includes accepting the tracking area request if the received first tracking area code is one of the first set of tracking area codes, or
each of the first set of tracking area codes is associated with a base station that does not support a circuit switched voice service, and accepting or rejecting the tracking area request includes rejecting the tracking area request if the received first tracking area code is one of the first set of tracking area codes.

15. The method as claimed in claim 14, wherein the first set of tracking area codes is associated with a base station that supports the circuit switched voice service, the management node stores a second set of tracking area codes and each of the second set of tracking area codes is associated with a base station that does not support a circuit switched voice service, and accepting or rejecting the tracking area request includes rejecting the tracking area request if the received first tracking area code is one of the second set of tracking area codes.

16. The method as claimed in claim 14, wherein the response message identifies the first tracking area code as forbidden.

17. A computer program comprising instructions which, when the computer program is executed by a computer, cause the computer to carry out the method of claim 14.

18. A computer readable carrier medium comprising the computer program of claim 17.

19. A management node for a cellular telecommunications network having a processor configured to carry out the method of claim 14.
